(19) United States
(12) Patent Application Publication
(10) Pub. No.: US 2014/0171332 A1
(43) Pub. Date: Jun. 19, 2014

(54) SYSTEM FOR THE EFFICIENT DISCOVERY OF NEW THERAPEUTIC DRUGS

(71) Applicants: Alan H. Katz, Lawrenceville, NJ (US); Philip J. Farrelly, Short Hill, NJ (US)

(72) Inventors: Alan H. Katz, Lawrenceville, NJ (US); Philip J. Farrelly, Short Hill, NJ (US)

(73) Assignee: Hudson Robotics, Inc., Springfield, NJ (US)

(21) Appl. No.: 14/098,404

(22) Filed: Dec. 5, 2013

Related U.S. Application Data
(60) Provisional application No. 61/733,714, filed on Dec. 5, 2012.

(51) Int. Cl. G06F 19/00

(52) U.S. Cl. CPC G06F 19/701
USPC 506/8; 506/7

(57) ABSTRACT

The invention provides for carrying out 3-dimensional similarity searching by comparing a probe molecule to each member of a 3-dimensional database. The probe molecule is overlapped with each member of a database of molecules and then the database molecule is rotated and translates until its similarity with the probe molecule is maximized. The system can contain ten different scoring functions to rate the similarity between the two molecules. Each function employs different molecular features when scoring a particular comparison. Some methods are based on the relative shape of the two molecules, and some are based on the overlap of key atoms such as oxygen, nitrogen, sulfur, and/or halogens.

### CROSS REFERENCE TO RELATED APPLICATIONS

This application is a non-provisional of Ser. No. 61/733,714 filed Dec. 5, 2012 which is incorporated herein as though recited in full.

### FIELD OF THE INVENTION

The invention described herein relates to the improvement of the efficiency of discovering new therapeutic drugs. It can be applied to any situation in which a laboratory assay exists that can measure a molecule's ability to affect the biological process of interest.

### BACKGROUND OF THE INVENTION

Drug companies begin many early stage drug discovery projects by searching for biologically active molecules in their corporate database, usually by running resource-expensive high-throughput screens. The goal of these screens is to identify a number of “lead” molecules. Lead molecules posses some, but not all, of the desired biological properties necessary of a molecule fit to undergo clinical trials in humans, and are the first step in developing a molecule that will ultimately reach the consumer market as a new drug.

A large portion of the drug discovery cycle involves the optimization of the lead molecules. A long process of data analysis, new molecule synthesis and biological testing continues until an acceptable clinical candidate is produced.

Computer-aided drug design (CADD) is an important component in the successful design of new safe and specific drugs. Models, derived from a variety of computational methods, are developed to rationalize how the biological activity of series of molecules varies as their chemical structure is changed. This information is crucial to help guide the medicinal chemist during this lead optimization process.

During the lead optimization process, many computational models are created. Just as accurate models can significantly increase a chemist's chances of synthesizing the ideal molecule, inaccurate models result in wasted time and resources.

It is therefore important to continually validate molecular models with biological assay data throughout the life of a discovery program. This is traditionally a slow process during which structural models of the (usually protein) targets are developed by experts, presented to, and evaluated by chemists, who incorporate them into their synthetic designs.

The length of the lead optimization process is greatly influenced by the quality of the lead structures obtained from high throughput screening. The closer the properties of the lead structure match the desired properties of a clinical candidate, the faster an acceptable molecule is likely to be found. To more accurately locate lead structures, drug companies have developed a variety of screening methods to find leads from among their large private collections of molecules that have been amassed throughout their history.

These collections often contain thousands or millions of compounds which have been synthesized as part of earlier projects or obtained from other sources. Many of these compounds are available in very limited amounts and are unlikely to ever be replenished. Many others are of questionable purity, while others may have reacted with the environment to form unknown structures.

Unfiltered, high-throughput screens represent a brute-force method of finding leads; however, they are very expensive, both in time and resources. Therefore, many companies look for more efficient ways of identifying leads that don't require such extensive testing.

Various methods have been developed to reduce the number of compounds that need to be screened. Companies create “focused” libraries in which molecules that are considered unlikely to show a desired activity are excluded. For example, the majority of drugs that are active in the central nervous system (CNS) contain a nitrogen atom with a positive charge, as well as at least one aromatic ring system. Therefore, CNS focused libraries include only molecules with these characteristics.

The more sophisticated alternative is a virtual screen, run on a computer. In this approach, molecules in the corporate database are evaluated in an appropriate 2- and 3-dimensional molecular model developed using computer-aided drug design. The better a molecule fits the model, the more likely it will share its biological attributes. Because virtual screens are typically run at the start of a new project, the models are necessarily based on limited information. The more information available, the more effective the corresponding virtual screen.

Virtual screens can use many types of computational models. The most straightforward involves computing the 2- or 3-dimensional similarity between molecules with known activity versus the molecules in the database. Many other approaches exist, such as measuring a molecule's theoretical ability to fit into the binding site of the protein target responsible for the biological activity of interest.

Predictions from standard virtual screens depend on the underlying scoring procedure; i.e. the way in which the computer measures a given molecule's fit to the model. The final result of this comparison is a number, or score.

Huge lists of hits are sorted by this score, and the top several thousand are typically selected. The more realistic the model and underlying scoring procedure, the more likely active molecules will be found at the top of the list. More specifically, the closer the match between the model and a molecule under consideration, the more likely it will be active.

A major problem with virtual screens is that most computational models are based on limited information, and are therefore not able to recognize molecules that are biologically active due to features not considered by the model. Incomplete knowledge of the actual, relevant structure of the target protein, as well as imperfect knowledge of all the factors which would cause a compound to bind to that protein leaves many potential leads unexplored. As a result, this technique, which is based upon available structural knowledge of the drug target, is readily susceptible to producing few active molecules.

### SUMMARY OF THE INVENTION

In accordance with an embodiment of the invention, a system is provided for carrying out 3-dimensional similarity searching by comparing a probe molecule to each member of a 3-dimensional database. The probe molecule is overlapped with each member of a database of molecules and then the database molecule is rotated and translates until its similarity with the probe molecule is maximized. The system contains ten different scoring functions to rate the similarity between the two molecules. Each function employs different molecular features when scoring a particular comparison.

In accordance with another embodiment of the invention, a probe molecule is selected, and the software overlays the 3-dimensional structure of the probe molecule with that of each molecule in the accessed database. It then rotates one molecule with respect to the other until a maximum similarity is achieved. Approximately 10 different methods to scoring similarity as can be employed. Some methods are based on the relative shape of the two molecules, and some are based on the overlap of key atoms (oxygen, nitrogen, sulfur, halogens, etc). There are also scoring methods that combine these two general approaches. A mechanism of inter-application communication can enable the system to locate the molecules suggested by the software, cherry-pick them from their storage plate, run the biological assay of interest and tell program which compounds are biologically active.

In accordance with a further embodiment of the invention a computer system is provided for finding in a collection of molecules, molecules that possess a desired biologically activity. The computer system comprises:

means for carrying out a laboratory assay and generating suggested molecules,

means for determining the biological activity of the suggested molecules,

means to aspirate and dispense liquids, and

a reader means for measuring a light-based signal that directly correlates to a sample's biological activity.

In accordance with another embodiment of the invention, a non-transitory computer readable medium has stored thereon, computer readable instructions which when executed by a computer causes the computer to perform the steps of:

using Computational chemistry (CADD) software, converting 2-dimensional molecular structures to 3-dimensions,

computing 3-dimensional molecular similarity between pairs of 3-dimensional molecular structures,

analyzing the results,

based on the results of the analyzing, compiling a list of suggested molecules to test based on a series of algorithms,

testing the suggested molecules in an assay,

retrieving the results of the assay from a reader and

determining which molecules to submit to the next iteration,

the next iteration comprising repeating the process with molecules determined for submission to the next iteration.

Additionally, the computer readable instructions cause the computer to compare each molecule available for testing with a limited number of probe molecules which are known to possess the desired biological activity and perform the steps of:

a. creating a plurality of 3-dimensional structures of each probe molecule, the probes representing different shapes accessible due to rotation of flexible atomic bonds;
b. comparing each 3-dimensional structure to every molecule in the database, and computing scores that quantify the similarity of each pair, and
c. combining, analyzing, and identifying the best candidates for laboratory testing.

In a further embodiment of the invention, the identifying of the best candidates for biological testing comprises the steps of:

a. sorting results using a predetermined scoring method;
b. generating lists of molecules based on the scoring;
c. selecting a top number of molecules from each list, wherein the number selected from each list is calculated by dividing the number of requested suggestions by the number of chosen scoring methods;
d. systematically evaluating a plurality of combinations of scoring methods and selecting the scoring method that produces the largest number of active molecules; and
e. receiving input from a user accepting the results,
f. receiving input from a user designating alternative scoring methods, or
g. proceeding automatically with no user intervention.

Subsequent to proceeding automatically with no user intervention a list of molecules generated in step (d.) and their physical locations are saved in a computer database. Additionally, the computer readable instructions cause instrument control software to instruct a robot arm, based on the list of molecules, to retrieve each vessel containing the molecules which are known to possess the desired biological activity. Additionally, a reader device analyzes the raw results from the reader, carries out computations to create a file containing the biological activity of each tested molecule. The file is stored and another iteration is run based on the biological activity of tested molecules in the file.

In still another embodiment of the invention, the non-transitory computer readable medium of is programmed to apply a two-tiered approach to generating suggested compounds for testing. The two-tiered approach comprises:

a. creating a limited number, preferably about five (5), 3-dimensional structures of each database molecule, the structures representing different shapes accessible due to rotation of flexible atomic bonds;

b. performing an analysis to obtain a further list of suggestions that accounts for a minority, preferably about 1-5%, of molecules in the database;

c. from the further list of suggested molecules, creating a plurality of 3-dimensional structures from each molecule, and performing an analysis based on the further list of suggested molecules; and

d. selecting a number of the top scoring molecules, as suggestions for actual testing in an assay, the number being less than the further list of suggested molecules

Preferably, the plurality of 3-dimensional structures is on the order of magnitude of 1000, the top scoring molecules are on the order of magnitude of 100. Advantageously, the limited number of 3-dimensional structures of each database molecule is in the range from 1 to 10% of the molecules in the database and preferably it is in the range from 1 to 5% of the molecules in the database.

In accordance with an embodiment of the invention, similarity is based upon similarity in shape, size and/or electrical charge to one or more molecules that are known to be active.

In accordance with another embodiment of the invention, a method is provided for finding in a collection of molecules, molecules that possess a desired biologically activity. The method comprises:
a. using a computer processor,
b. processing computational chemistry (CADD) software and converting 2-dimensional molecular structures to 3-dimensions,
c. computing 3-dimensional molecular similarity between pairs of 3-dimensional molecular structures,
d. analyzing the results,
e. based on the results of the analyzing, compiling in a computer database, a list of suggested molecules to tested,
f. testing the suggested molecules in an assay,
g. retrieving the results from the assay and determining which molecules to submit to the next iteration, the next iteration comprising repeating the process with molecules determined for submission to the next iteration. The testing of the suggested molecules in an assay can comprise determining the biological activity of the suggested molecules, using a reader means for measuring a light-based signal that directly correlates to a sample's biological activity.

### BRIEF DESCRIPTION OF THE DRAWINGS

FIG. 1 is a serotonin molecule showing the receptors;

FIG. 2 is a serotonin molecule and a Prozac molecule showing the receptors;

FIG. 3 is an example drawing of the probe molecule and circles indicating similarity levels and a biologically active cone of molecules;

FIG. 4 is the example drawing of FIG. 3 indicating the location of Prozac in relationship to the serotonin probe;

FIG. 5 is an example drawing indicating the biologically active and biologically inactive molecules in the example above;

FIG. 6 is an example drawing illustrating the similarity circles based upon new probe molecules;

FIG. 7 is an example drawing of the biologically active and biologically inactive molecules based upon the new probes of FIG. 6;

FIG. 8 is a the initial virtual screen in accordance with the invention;

FIG. 9 is a view of the probe selection screen in accordance with the invention;

FIG. 10 is a view of the interactive hit screen in accordance with the invention;

FIG. 11 is a flow chart of the operating sequence screen in accordance with the invention;

FIG. 12 is a graph illustrating results achieved with the disclosed system; and

FIG. 13 is a flow chart of the Softlinx software.

### DESCRIPTION OF THE INVENTION

### Definitions

As used herein the term “assay” refers to subjecting a substance to chemical analysis to determine candidates for biological testing. Additional use of assay is the substance that is to be assayed and also means the results of the assay.

As used herein the term “database” refers to any internal or read/write or read only external database that is being accessed by the system.

As used herein the term “shape comparison software”, or “SCS”, refers to any software that provides the ability to identify and measure the similarity and dissimilarity of two objects, such as molecules. An example of such software is ROCS by OpenEye Scientific Software.

As used herein the term “readers”, means the devices of U.S. Pat. Nos. 6,930,314, 5,112,134, 8,496,879, and 8,119,066, and patents, patent applications, and publications disclosed therein.

As used herein the term “In silico” performed on computer or via computer simulation.

As used herein, the term “order of magnitude” refers to the smallest power of ten needed to represent a quantity. Two quantities and which are within about a factor of 10 of each other are then said to be “of the same order of magnitude”.

The system of the present invention takes previously autonomously run systems, coordinates these systems with novel algorithms and software, to match biological active molecules to a selected probe molecule.

Examples of autonomously run software that are automated by the disclosed system are OMEGA for generating conformations from 2D structures and ROCS for finding the best overlap between a probe molecule and a database molecule. Both of these example products are manufactured by OpenEye Software. Other, equivalent products can be used.

The value of the disclosed invention arises from the fact that molecules active against a target protein involve some combination of size, structure and electronics. This invention provides an automated systematic method for predicting compounds' activity based upon different measures of similarity among these factors with other compounds known to be active against a target protein.

Once a probe molecule is selected, the software overlays the 3-dimensional structure of the probe molecule with that of each molecule in the accessed database. It then rotates one molecule with respect to the other until a maximum similarity is achieved. ROCS provides 10 different methods to scoring similarity as described hereinafter. Some are based on the relative shape of the two molecules, and some are based on the overlap of key atoms (oxygen, nitrogen, sulfur, halogens, etc). There are also scoring methods that combine these two general approaches. A mechanism of inter-application communication can enable the system to locate the molecules suggested by the software, cherry-pick them from their storage plate, run the biological assay of interest and tell program which compounds are biologically active.

The system is applicable for use in a number of common drug discovery situations. In each case, the invention introduces advantages over the current standard approaches. Examples of applications are:

1. Finding molecules that are active against a biological target. The two main alternative approaches are high-throughput screening and computer-assisted virtual screening. A number of different common scenarios can be handled by this method:
A. Molecules are known that operate by the same biological mechanism: In this case, these molecules are compared to each member of the database.
B. No molecules are known that operate by the same biological mechanism. In this scenario, the program searches the database for a small subset of diverse molecular structures to test. This procedure repeats until active molecules are found and the process then continues as in scenario A.

2. Search a database for molecules that are selectively active against one biological target but not against a similar biological target. Such molecules would have an improved side effect profile. The only way to accomplish this goal using high-throughput screening is to run two complete screens, one for each desired biological activity. The current invention can be expanded to multiple biological targets.

3. Develop a model that correlates the biological activity of a molecule with its chemical and structural features. This information cannot be obtained directly from a high-throughput screen, but is automatically generated as part of this invention's output.

4. Plan and prioritize new synthetic targets with the goal of maximizing the biological activity of the initial screening hits. The current invention applies the scoring schemes it learned during the database screen to sort a list of synthetic proposals based on their predicted biological activity.

The system can be “trained” by employing a “pilot” database containing molecules of known biological activity. After several iterations, it will develop a predictive hypothesis that can be applied to a larger, corporate, database. This approach can be used to evaluate molecules that are being considered for synthesis. The system can also connect directly to a number of commercial websites that sell chemicals and search for, and purchase, molecules that are highly likely to possess the desired biological activity. The system contains, or can access, a database that contains the identities of the desired compounds, and sufficient information to locate and retrieve them. An example would be a database containing the identity of the compounds, their storage vessels' locations in a storage vault or other physical storage device, and sufficient detail to locate the particular compound either via automated or manual means.

Means for delivering the selected vessels containing the compounds to a location where a desired amount of each of the desired compounds can be withdrawn from their storage vessels, by, for instance, a robotic or manual pipettor, and placed into another vessel, such as a microplate. This microplate could then be delivered to, for example, a robotic system which processes its contained compounds through a valid assay (for example, an ELISA) to identify the presence and strength of each compound's activity relative to the target protein.

The process operates through a series of iterations. In each iteration, the software program compiles its latest suggestions by comparing molecules in the corporate database with the biologically active molecules found in the previous iteration. Each iteration can be run without user intervention, in a fully-automated manner. Alternatively, the user can examine the suggestions as well as alternatives.

The system lists all of the comparisons it has made and sorts them by numerous criteria. The top molecules from each sort are combined to produce the final list of suggested molecules to be assayed. Sorting is based on the scoring functions that were chosen for a given analysis. Usually multiple scoring approaches are combined and the program chooses enough compounds from each list to fill a single microplate. This number can be set to 24, 96, 384, etc. 96-well plates can be employed, even if only 24 compounds are considered. The software provides a filtering feature which is applied before the scoring functions are considered. The filtering can be particularly beneficial during manual examination of the suggested molecules before the physical testing begins.

Examples of scoring functions that can be used, using ROCS software, include:

### 1. Tanimoto Combo

### 2. Tanimoto Color

### 3. Tanimoto Shape

### 4. FitTversky Combo

### 5. FitTversky Color

### 6. FitTversky Shape

### 7. RefTversky Combo

### 8. RefTversky Color

### 9. RefTversky Shape

### 10. ScaledColor

These scoring functions can be organized into 3 main categories that identify the relative weight given to the probe versus each molecule in the database, when making a similarity comparison.

1. Tanimoto—The probe and each database entry are given equal weight.

2. FitTversky—In this approach, the entire structure of the probe is considered, but only the portion of the database molecule that matches the probe calculated. This method is most successful when the database contains molecules that are generally larger than the probe.

3. RefTversky—This is the opposite of FitTversky. Here the database molecules are smaller than the probe molecule.

Each of these scoring methods can be further subdivided based on whether or not they take shape or electronic features into account.

1. Shape—Similarity is totally based on the relative shape of the two molecules being compared.

2. Color—Ignores shape and calculates the root mean square deviation of pairs of key atoms in each molecule. For example, if both molecules contain a positively charged Nitrogen atom and two Oxygen atoms, the program rotates the two molecules until these three atoms overlap in the best possible way, regardless of the relative shapes of the molecules.

3. Combo—This method combines Shape and Color to provide a composite score. It is usually divided 50:50, but the expert can try other variations.

### Training

In some instances it can be beneficial to run the system against a “training set” containing a representative set of known active molecules and a larger number of known “decoys” (ie. Inactive molecules that are similar to the known active molecules). The system can then determine which scoring criteria lead to the best predictions. This information can then be applied to a database of untested molecules.

The training follows the same exact steps as the normal process described in the step-by-step description. The only difference is that the molecules in training set have been named so that the software can systematically determine the success of every scoring function under consideration. In a normal database, the molecule's name doesn't indicate its activity, so physical screening is required. Although it is possible to test every compound that appears on every scoring function list, but that will end up defeating the purpose of the system and will result in much lower hit rates.

A training algorithm systematically It's the same algorithm, just run repeatedly to see which combination of similarity metrics gives the best result tries every possible combination of 1-6 different scoring functions as noted above. For each combination, it calculates the number of actives selected (based on the name of the molecule). The combination of scoring functions that produces the greatest number of previously known hits is selected. It is common to find more than one combination that result in the same number of actives. The system can be set to select the last one it finds.

The next step compares each of the scoring schemes that results in the maximum number of hits and chooses which one to adopt based on several criteria. These criteria include:

Did the same scoring scheme work well on any earlier probes?

Is there redundancy amongst the scoring methods in a given scheme, eg. Tanimoto Color and Scaled Color are often highly correlated.

Do any of the successful scoring functions favor one of the conformations generated for the probe? This can be very useful in predicting the shape of the molecule bound to the protein.

How different are the hit lists from the different scoring schemes? Redundancy in the lists gives greater confidence in the result.

In each iteration of a training screen, every possible combination of scoring functions is evaluated. The system's algorithm tracks the effectiveness of each scoring function in finding active molecules. This analysis provides information about how the factors of size, shape and electrical charges interact to affect the activity of molecules against this particular target.

### Components of the System

High Efficiency Screening (HES) Application

This novel software, is responsible for setting up and running computational chemistry calculations as well as retrieving and analyzing the results. It then produces a list of suggested molecules to be tested in a biological assay.

Through the use of algorithms unique to the system, the user screens are manipulated, based on input in the following areas:
Probe Molecules
Database to screen
Maximum # of Probes to us in an iteration
Maximum # of Conformations to create for each molecule (probe and database)
List of similarity metric(s)
Number of desired suggestions
Maximum biological activity to be considered a hit (Cutoff)

### 2-D to 3-D Structure Coversion Software

This software converts 2-dimensional structures into 3-dimensions. It is used to convert a database of 2-dimensional molecular structures into a 3-dimensional database. Most drug-like molecules contain rotatable bonds which allow them to adopt different conformations. In most cases one of these shapes is responsible for the observed biological activity while other shapes are not active, or can be responsible for a molecule's undesired side effect profile. The process of the present invention directs this software to create a specified number of conformations for each molecule it converts.

### Similarity Search Software

This program carries out 3-dimensional similarity searching by comparing a probe molecule to each member of the 3-dimensional database created by Omega or similar software. This would be in most instances an existing database owned by a company, however the system can be used with combinations ith any private or public database using any compatible 3D software. The program overlaps the probe molecule with each member of the database and then rotates and translates the database molecule until its similarity with the probe molecule is maximized. ROCS contains ten different scoring functions to rate the similarity between the two molecules. Each function employs different molecular features when scoring a particular comparison.

### Laboratory Instrumentation

The physical system consists of tools and instruments, including microplate-handling and liquid-handling robots connected to a multimode reader that can carry out the desired biological activity and produce reproducible, accurate results.

This instrumentation can be run manually, or controlled via lab automation software. In either case, a text file containing the names of the tested molecules with the observed biological activity must be made available to the invention.

Although above identified components are preferred, it should be noted that any equivalent component can be used. Changes to the sequence of the workflow or the commercial software for use therewith will be obvious to one skilled in the art.

### Basic Workflow Example

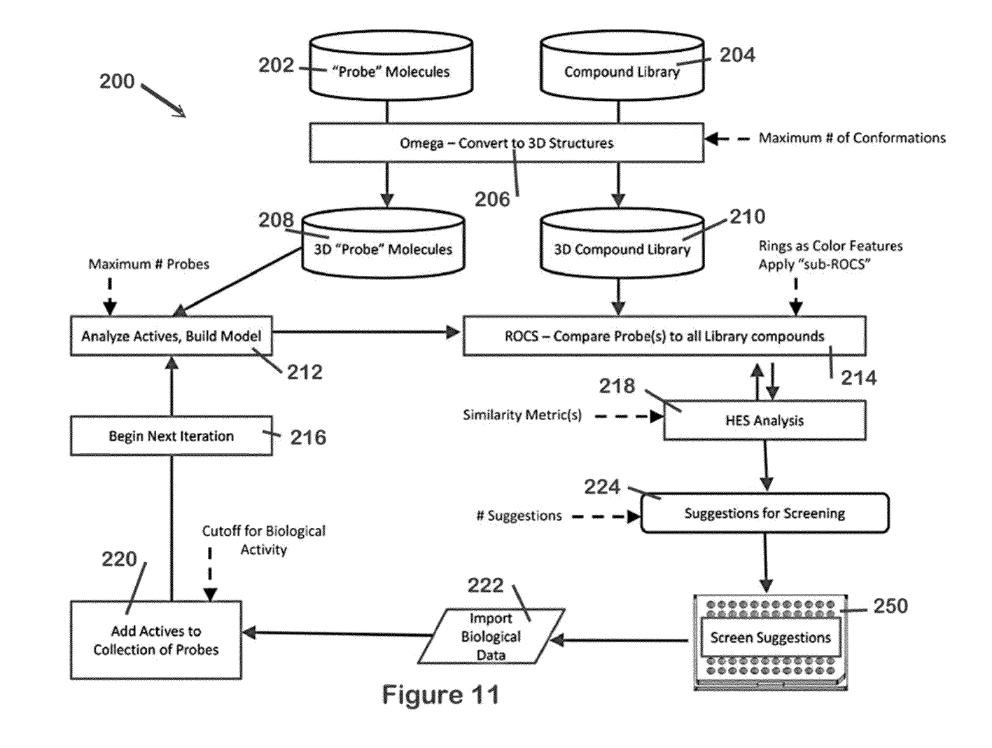

An example of a basic workflow, as illustrated in FIG. 11, is as follows:
1. Probe molecules 202—identification of a small number of representative, potent, molecules which are known to be active against the target of interest, to be used as probes.
2. Compound library 204—search a database of available molecules for those that are similar to the probes (examples of software being ROCS by Open Eye, or PHASE by Schrodinger).
3. Convert to 3D Structures 206—the compounds from the compound library 204 and the probe molecules 202 are converted to 3D structures for subsequent comparison. The conversion is submitted to the appropriate software, such as OMEGA, with the user's requested number of conformations.
4. The 3D Probe Molecules 208—the converted molecules are stored in a database.
5. The 3D compound library 210—molecules are stored in a compound library
6. Analyze Actives, Build Model 212—the 3D probe molecules are analyzed for bioactivity and the models are constructed for comparison with the library compounds 210.
7. ROCS—compare probes to all library compounds 214—the models are compared with the existing models from the library compound 210 for molecules matching the probe molecules in one or more of the criteria set forth herein. This process is done for each iteration, with the available probes and the list of molecules in the database compared. The number of comparisons, the square of the number of conformations, needing to be run is calculated, Depending on the system, the comparisons can be distributed to a number of worker computers on the network. The workers report back to the main program, which in turn updates the user with the programs progress.

If the user requests a maximum number of probes, and the system contains more than the requested number, a simple algorithm to limit the number of probes to the maximum. For example the algorithm could use Tanimoto similarity to maximize the diversity of the probes, a cluster analysis or other determination to avoid redundancy.

Each ROCS comparison produces a “best fit alignment”, which is stored and used to calculate a similarity value based on each method requested by the user (eg. Tanimoto, Scaled Color, Overlap). This data is stored to be retrieved in the subsequent analysis step.
8. HES Analysis 218—analyze the results by applying different combinations of similarity scoring schemes. For each similarity metric chosen, a list of comparisons is compiled and the top X molecules taken. For example, if the user chooses 4 similarity metrics and asks for 100 suggestions, the first 25 suggestions are taken from the top of the first similarity metric list. Those molecules are then removed from consideration and generate a second list using the next metric. The top 25 from that list are then chosen and continued for all 4 metrics. This approach means that all of the suggestions could potentially come from only one probe. However, this approach guarantees that there will some diversity to the hits, assuming the user chose a diverse selection of similarity metrics.
9. Suggestions for Screening 224—a list of molecules is produced that are suggests for assay from among those identified as most similar to the probe or probes. The list can be displayed as 2D, 3D or simply molecule names and/or numbers.
10 Screen Suggestions 250—the suggestions for screening 224 are displayed for optional user input as to specific molecules to be assayed.
11. Import Biological Data 222—the selected molecules are retrieved from storage, the molecules assayed and the biologically active molecules determined. At this point, the program pauses and waits for the user to carry out the biological screen of the suggestions. This process can also be automated and can be carried out by a program such as SoftLinx. If the user does this, then all iterations can be carried out unattended. Otherwise, the user has to generate a text file containing the biological data for each of the suggestions.
12. Add Actives to Collection of Probes 220—the molecules that are determined biologically active are then converted to probes for the next iteration. If the user does not want all active probes to be added to the next iteration, a maximum number can be selected. This can be accomplish by user selection or the system selecting the top X number.

The history of the new probe molecules can be recorded with it success rate of the finding of an active molecule. Probes that find no, or few, active molecules can be eliminate from the system or tagged accordingly, remaining in the database.
13. Begin Next Iteration 216—the above process 212-220 is repeated for the currently converted probes. The process is repeated until no more biologically active molecules can be found in the library.

A guiding principle behind drug design is that molecules acting by the same biological mechanism will share certain chemical attributes that are recognized by their common protein target. These attributes fall into two major categories: size, shape and electrical charge.

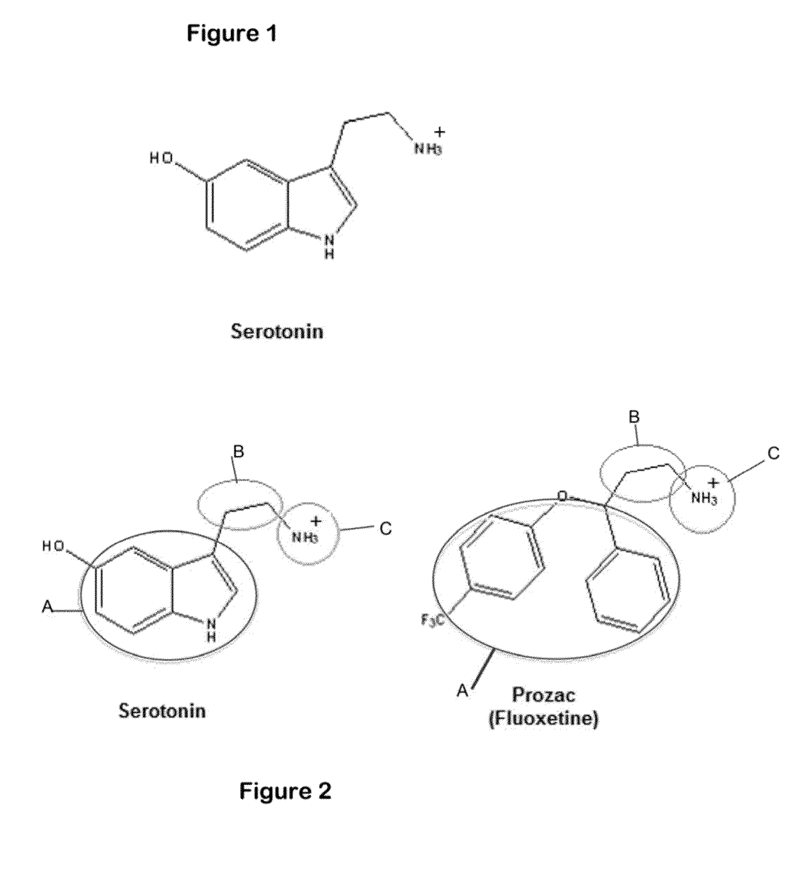

For example, as illustrated in FIG. 1, Serotonin (5-hydroxytryptamine) is a neurotransmitter involved in the movement of nerve signals across the synapse between two axons.

Depression is often associated with lower levels of serotonin in the synapse due to over activity of the presynaptic serotonin reuptake receptor. Many commercial antidepressants act by blocking this receptor, and therefore, must contain chemical features in common with Serotonin.

For example, as in FIG. 2, Serotonin and Fluoxetine (Prozac) both contain a positively charged amino group (NH3+, circle C) attached to 2 carbon atoms (oval B) which interact with a negatively charged Aspartic Acid residue in the active site of the receptor. They also contain six-member aromatic rings (oval A) that occupy similar positions in space compared to their corresponding amino groups. These similarities are expected since both molecules bind to the same site of the same protein.

A drug company looking for a new Serotonin-mimetic could do so in two different ways. They can develop a biological assay that measures the binding of small molecules to the Serotonin Reuptake Receptor and run a high throughput screen. Or they can carry out a virtual screen by looking for molecules that are similar to Serotonin. The latter is typically carried out by running a ROCS-type similarity search with the most potent known ligand (or multiple ligands) as a probe, or model, for the search.

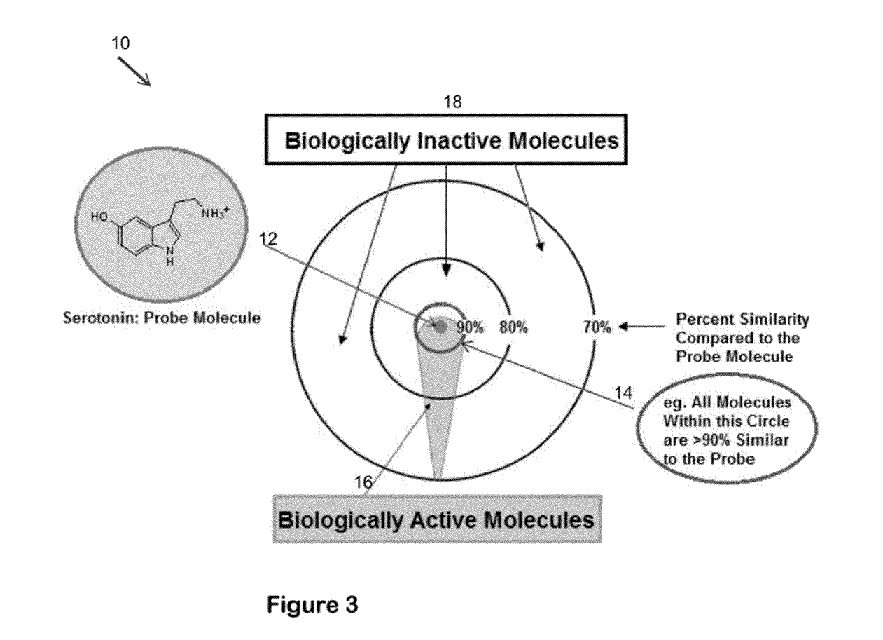

Although the virtual screen is much less resource-intensive, it rarely replaces the high throughput screen. This is because the hit rates achieved with virtual screens are on the order of 5-10% at best. This can be explained by examination of the diagram in FIG. 3. The small circle at the center of the FIG. 3 corresponds to the probe molecule 12, for example, Serotonin. The subsequent, or similar circle 14, represents the region containing all of the molecules in a compound collection that are 90% similar to the probe (Serotonin), and will usually correspond to fewer than 100 molecules out of a million. The area of the circle rapidly gets larger if the similarity cutoff percentage gets smaller, as many more molecules will meet that criterion. The shaded cone region 16 corresponds to the molecules in the collection that actually would possess the desired biological activity (eg., affinity for the Serotonin Receptor) if they were physically tested. The higher the similarity to the biologically active probe, the greater the chance that the molecule will possess the same activity. Conversely, the width of the shaded cone region 16 contracts as the percentage similarity goes down.

Most virtual screens are run with a small enough similarity cut off to produce a large list of molecules to be submitted for screening. A typical value would be 70% (the default cutoff in ROCS). Moving to the outermost cutoff ring 18 of FIG. 3, one can see the percentage of active molecules resulting from physical testing would be quite small and is consistent with the typical hit rates of 5-10% (ie. the width of the shaded cone region 16 has become very small).

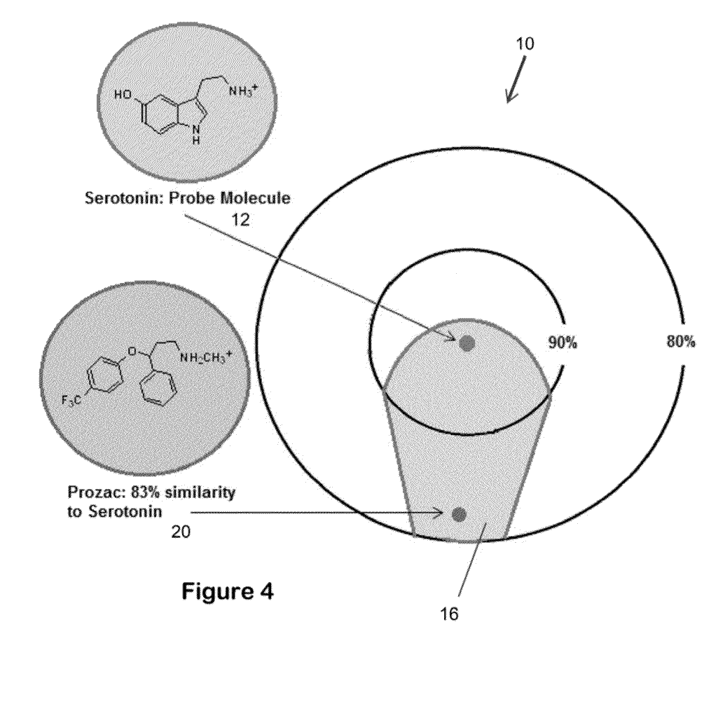

In the Serotonin example, one would have to screen every molecule with at least a similarity level of 83% to find Prozac (See FIG. 4).

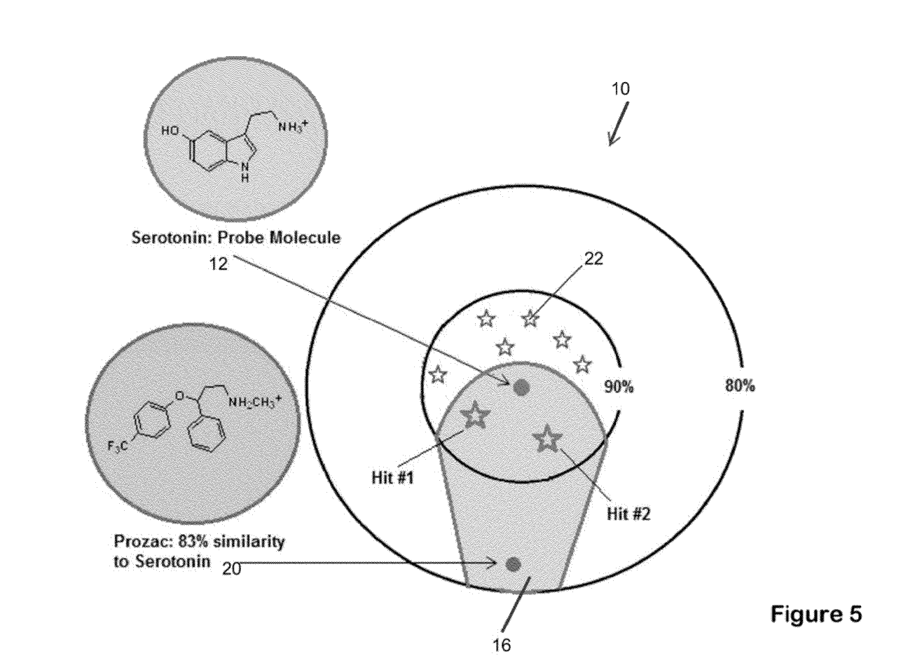

Such a search will find Prozac 20, as well as all of the other active molecules that reside within the shaded cone region 16. But this same search will also find the much greater number of inactive compounds that lie outside the shaded cone region 16, (FIG. 5) which would be the “false positives” of the virtual screen.

This type of inefficient result is so common that most drug companies will run the high throughput screen regardless what is achieved in the virtual screen. Such a large number of false positives in these virtual screens mean that one would have to physically screen the vast majority of the collection to find each active molecule.

The current invention increases the efficiency of a virtual screen by carrying out a series of smaller, directed searches with much higher percentage of similarity cutoffs. FIG. 5 demonstrates this approach by showing the results from a similarity search using Serotonin 20 as the probe and a similarity cutoff of 90%. Each Hit #1 and, Hit #2 represents a hit from the virtual screen.

After physically testing only these compounds the system determines that only the two molecules, represented by an X (Hit #1, Hit #2), are actually biologically active. The stars 22 in FIG. 5 correspond to molecules that have a similarity of at least 90% but do not possess the desired biological activity (i.e. false positives). The Hit #1 and Hit #2 show the molecules that both meet this similarity criterion and are active. As an alternative, the testing can be done manually. If done by a user, the creation of a text file containing the biological data is required.

In this approach, one would not expect to find Prozac in this first iteration of the process, because it doesn't meet the 90% similarity criterion. Rather than expand the search to include less similar compounds, it has been determined which of the virtual hits shown in FIG. 5 are active and use them as the probe molecules in a second iteration of similarity searches, maintaining the 90% similarity criterion, but around these molecules.

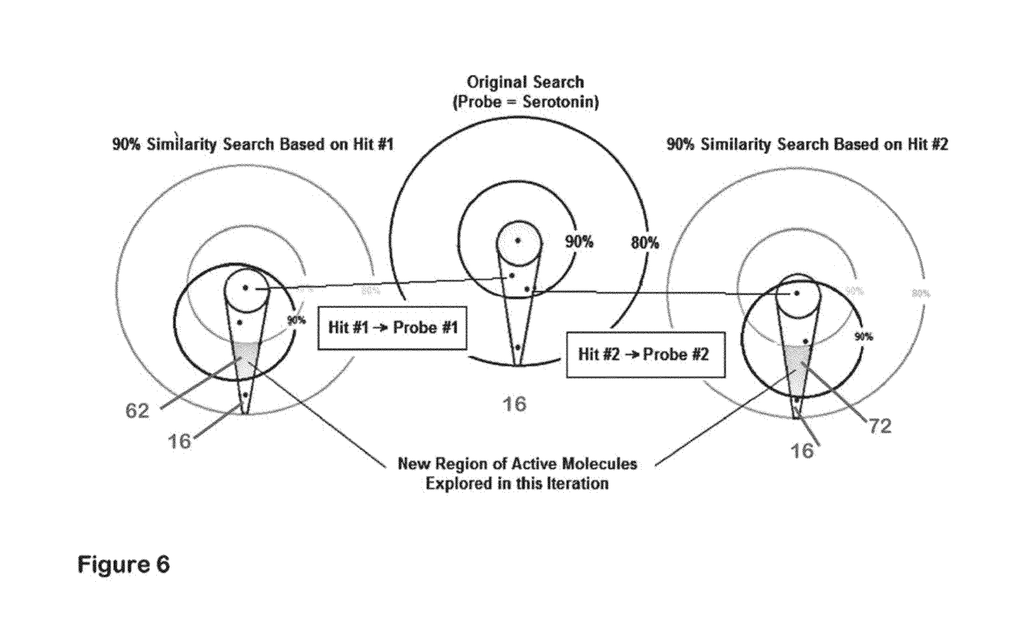

This process is depicted in FIG. 6, in which the inactive molecules, represented as stars 22 in Figure Five have been discarded, and the active molecules identified as Hit #1 and Hit #2 have been converted to probe molecules with Hit #1 becoming Probe #1 and Hit #2 becoming Probe #2.

In the next iteration, probe #1 and probe #2 have replaced Serotonin 12 as the probe molecule. New searches corresponding the 90% similarity criterion in relationship to the new Probe #1 and Probe #2 of the prior search are established. For example, the left side of FIG. 6 shows probe #1 with the location of the center of this 90% similarity circle being different from the 90% similarity of Serotonin. The 90% similarity circle corresponding to Probe #1 explores a secondary region 62 of the shaded cone region 16. This secondary region 62 corresponds to molecules that are less than 90% similar to Serotonin, but greater than 90% similar to probe #1,and would not have been considered in the first search. A similar depiction for probe #2 is shown on the right side wherein the secondary region 72 is explored. It should be noted that the circles used herein are only meant to illustrate the concept of how the measurement of similarity is based on the particular probe. The 90% is also meant for illustration. The actual similarity limits depend on the nature of the database. If there are no compounds of high similarity to the probe, the best hits will be further away from the center of the circle—which represents 100% similarity. Optimally the system locates the top x compounds which will, in some cases bring the similarity down to 90%, and other cases it will take the similarity down to 75%. The lower the similarity, the more likely to have more inactives among the suggestions.

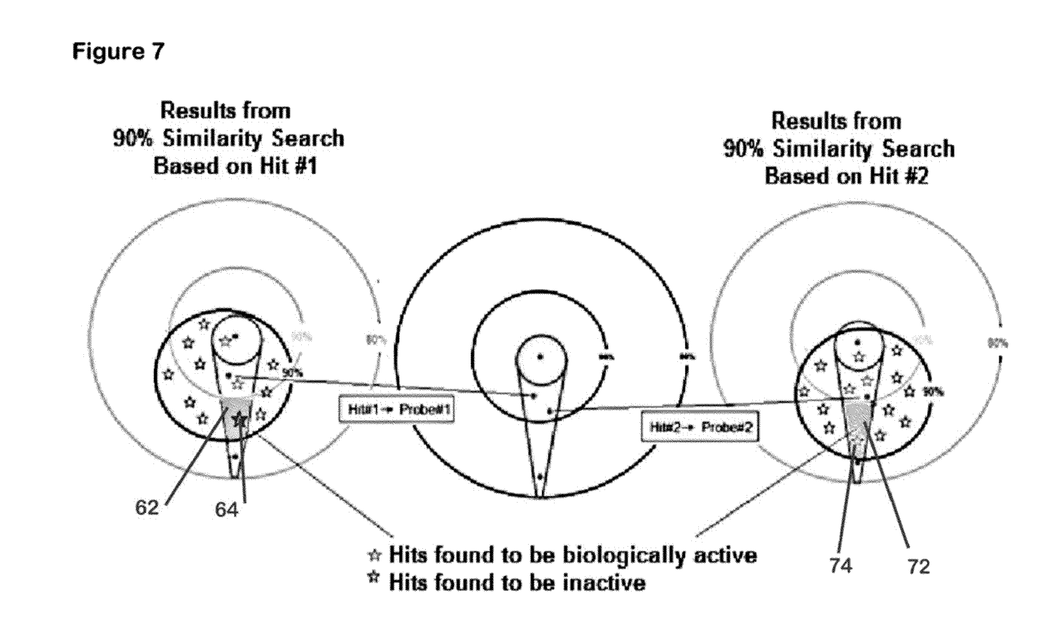

In both of the above cases, a vast portion of the inactive molecules have not been screened. FIG. 7 shows the typical results from these two searches. The secondary regions 62 and 72 corresponding to Probe #1 and Probe #2 on the left and right side of FIG. 7 respectively correspond to biologically active regions 64 and 74 that were outside the original 90% similarity criterion.

This process is continued until no more active compounds are found. As additional probes are identified with lower similarity to Serotonin, more of the shaded, active region is explored. In this way, active molecules, such as Prozac, are found without needing to test a vast majority of inactive molecules based only on Serotonin as the probe.

The algorithm doesn't consider any molecule that was identified in an earlier iteration, so the only top hits from the new virtual screens are selected and screened. Again, the active molecules become probes for another iteration of virtual screens, followed by confirmation in the biological assay.

This process will gradually move further and further away from the initial probe, as will the majority of active molecules, including Prozac. Because each screening set is confined to high similarity with respect to the corresponding probe, one never gets very far from the portion of the diagram corresponding to the desired biological activity. As the similarity of the probe moves further away from the initial query, larger numbers of molecules that do not contain the desired activity are avoided.

### Requirements

In order to carry out High Efficiency Screening, at least the following is required:

1. Biological Assay:

The basic premise behind the disclosed process is that the biological activity of a molecule is attenuated in a predictable way by changing its structure. For this reason, in vivo assays are inappropriate, and cellular assays are generally less useful than in vitro biochemical assays, unless they are working by a single biochemical mechanism In such cases, the system will find molecules that give the same functional response, presumably by the same biochemical mechanism, even if unknown. This fact a makes the system potentially useful to support phenotypic screening,

It is also important that the biological process in question involves, as a rate determining step, specific interactions between a small organic molecule and a protein. Biological mechanisms involving multiple steps, non-specific small molecule binding, and unrelated rate determining steps (such as membrane transport) are all less likely to result in useful predictions by this method

2. Probe Molecules:

A good probe molecule is one that is known to bind specifically to the protein of interest, preferably at very low concentration (less than micromolar, for example). Multiple probe molecules can be used, but this feature is most useful if the each probe is significantly different, or distinct, from the other. If a probe is too similar to another probe, it will not add new information and is unlikely to suggestion molecules different from the other probe. In addition to high potency, molecules that contain a significant number of differentiated chemical features provide more information to the system in its search for novel structures.

Probe molecules can be input into the system as 2-dimensional or 3-dimensional structures. 2-Dimensional structures must be in SMILES format, a well-known open source alphanumeric linear notation originally developed at Daylight Chemical Information Systems.

The system of the present invention suggests new molecules for testing by carrying out a series of similarity searches in which probe molecules are compared to the molecules in a 3D database. The databases used in the current implementation of this invention were created by converting a list of molecules stored in SMILES format into 3-dimensions using the OMEGA program from OpenEye. The first step in the process is the creation of a searchable molecular database by creating, for instance, a text file listing all of the molecules available to the researcher along with the corresponding SMILES notation and converting it into 3D with Omega (OpenEye).

The results reported here are based on a library created with 5 conformations generated for each molecule. The database in this example contains 116 molecules that are know to inhibit P38 and 2500 decoys molecules (i.e. molecules that are inactive against P38, but are chemically related to the know active molecules).

The following paragraphs describe the execution of a High Efficiency Screen using the disclosed software developed to assist in this process as an example of what would be a typical application.

### Step One: Preparation

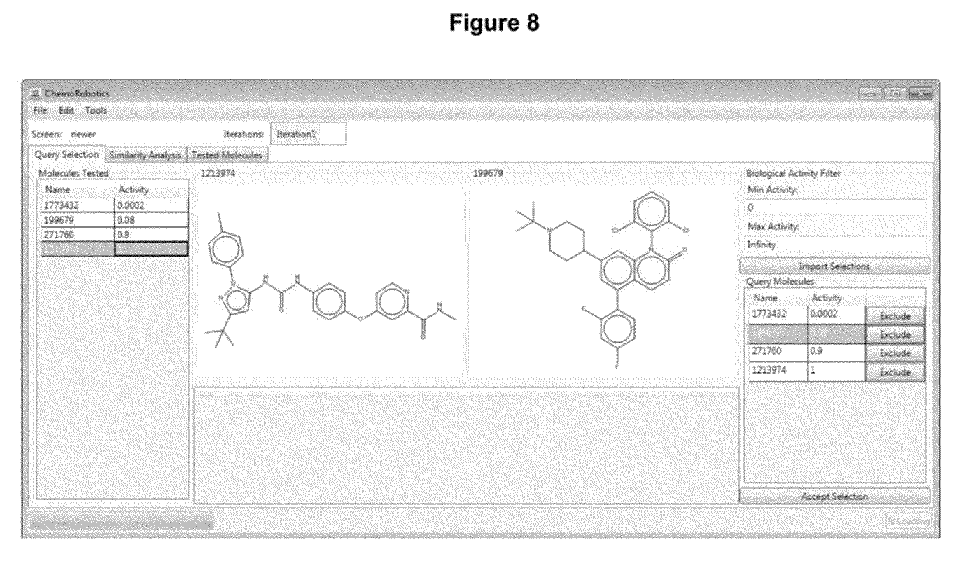

The user begins the process, using the disclosed system, by creating a new screen, naming it, selecting several starting probe molecules, and identifying the searching database. In this example screen illustrated in FIG. 8, a new screen was created and a file containing 4 molecules in SMILES format was selected. It is suggested that these probes be chosen to represent the most potent members in each known diverse chemical series. The greater the variation in the starting structures, the greater the expected enrichment of hits obtained.

### Step Two: Probe Selection 100

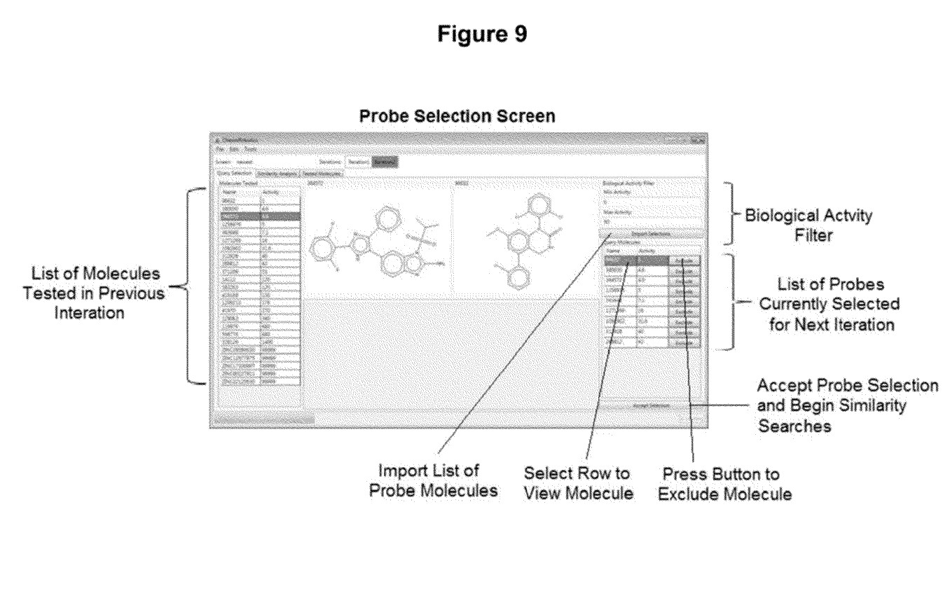

In the first Iteration, shown in the example screen illustrated in FIG. 9, the user only sees the starting probe molecules selected when creating the screen. To proceed with this list, press the “Accept Selection 106” button to lock down these choices and begin the similarity searches.

Additionally, the left column can be set up to display a list of molecules tested in previous iteration 114. The list on the right begins with the same list, but this will be trimmed down to the desired probes for the next iteration. There are three ways to trim the list down to a reasonable set of probes.

1—In the Biological Activity Filter 102 section, enter a minimum and/or maximum activity threshold to remove less active compounds from the table.

2—Compounds can be removed one at a time by selecting a row 110 and pressing the corresponding “Exclude” button 108. The structure appears in the window on the right when the row is clicked. It appears in the window on the left if you double-click on the row. This provides a simple way to compare two structures.

3—A list of molecules can be selected by pressing the “Import Selections” button 112 to provide a list of molecules for review and selection. The software will exclude any other molecule currently in the list. For example, the list may contain the most active members of each duster from a diversity analysis calculation.

### Step Three: Similarity Searching

A series of similarity searches will begin as soon as the “Accept Selection” button 106 is pressed. The amount of time to complete this step is proportional to the number of probes and the size of the database being searched. On a fast computer, at present, a 100,000 compound database will take around 30 minutes per probe. The program will take advantage of multiple processors, which can greatly reduce the time required for this portion of the process.

### Step Four: Similarity Search Analysis

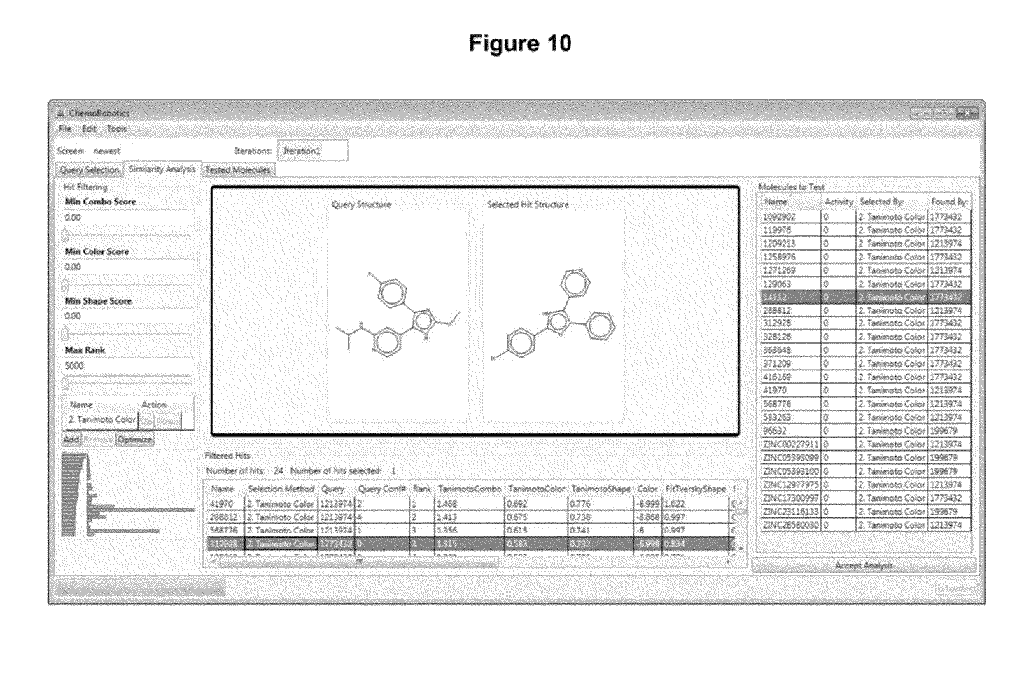

When all of the ROCS searches are complete, select the current iteration (“Ilteration2” in this example), and then press the “Analysis” tab. User will be brought to the screen illustrated as an example herein as FIG. 10.

As an option, a list of suggestions can be presented and modified by manipulating the sliders, or other indicators on the screen 150. When satisfied with the final list, pressing “Accept Analysis” does several things: it locks down the selection, creates a new iteration, and, in this example, returns control to the SoftLinx software.

SoftLinx, coordinates the retrieval of the selected compounds from storage and transports them to the pipettor to be cherry-picked. The system will then set up the assay, place the plate into the reader, and activate it. Upon completion, SoftLinx will notify user that new results are available in preparation for the next iteration.

Several things happen after accepting the selection. First, the list of probes becomes locked for the current iteration; the 2-dimensional structure of each probe is then extracted from the database and converted to 3-dimensions by running Omega. Omega is instructed to generate up to 5 different conformations for each molecule and a ROCS similarity search is then run using the resulting multi-conformer molecule file as the probe.

When all of the ROCS jobs reach completion, the user presses the “analysis” tab of the current iteration to view the list of 96 suggestions (e.g., the capacity of a single microplate) for biological testing. A multi-step proprietary method, as illustrated in FIG. 11 and described in more detail herein, has been developed to compile this list.

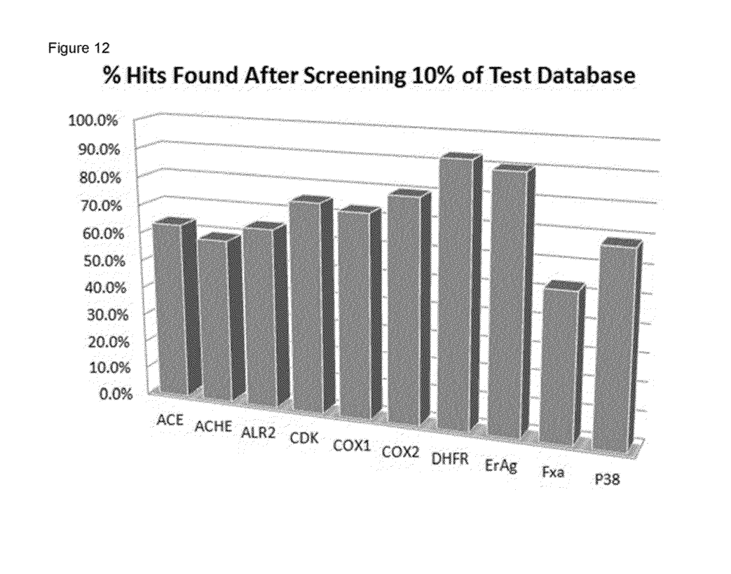

FIG. 12 illustrates test results obtained using the disclosed system. In testing against known compound databases, the disclosed system has consistently identified the majority of known inhibitors of 10 different biological targets after screening an average of 1-10% of a diverse library containing approximately 80,000 molecules.

### Inhibitors in Study

### ACE—Angiotensin Converting Enzyme (19)

### ACHE—Acetycholinesterase (17)

### ALR2— Aldose Reductase (14)

### CDK—Cydin-Dependant Kinase 2 (56)

### COX—Cyclooxygenase 1 & 2 (11)

### DHFR—Dihydrofolate Reductase (14)

### ERAg—Estrogen Receptor (Agonists) (10)

### FXa—Factor Xa (19)

### P38—P38 Mitogen Activated Protein Kinase (57)

Inhibitors were taken from the DUD collection (Huang, Shoichet and Irwin, J. Med. Chem., 2006, 49(23), 6789-6801. doi 10.1021/jm0608356)

The first number in parenthesis indicate the number of inhibitors included in the database. The number represents the number of unique dusters identified for each biological target. One member of each duster was used. The second number indicates the corresponding number of decoys included in the database.

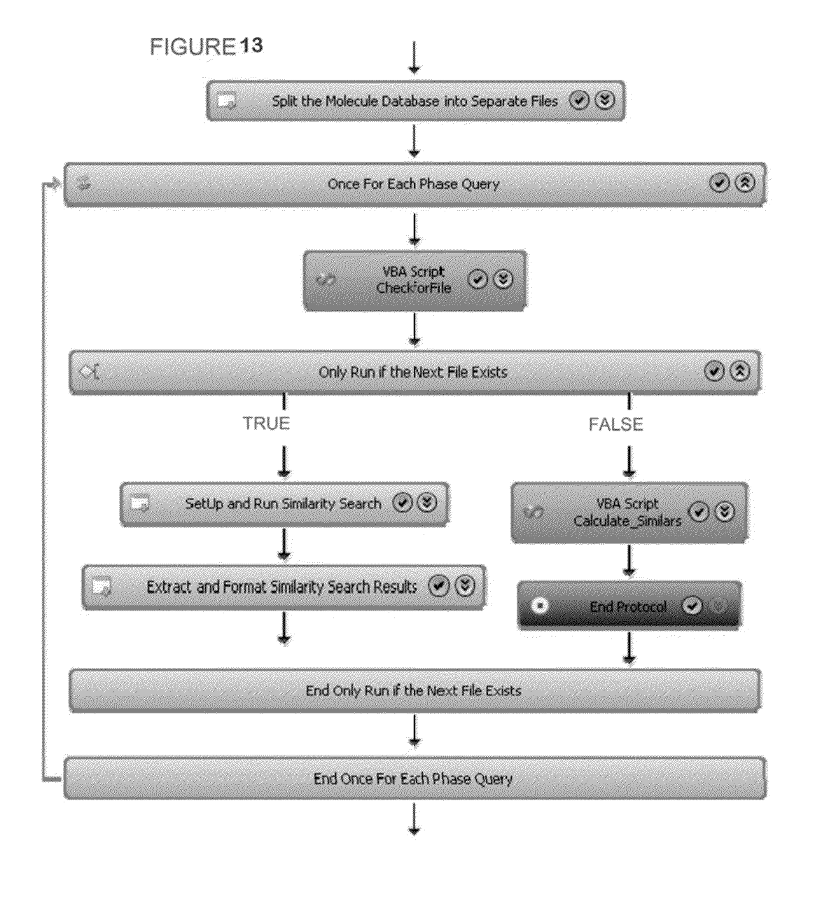

FIG. 13 is a flow chart of the Softlinx software when used to coordinate the disclosed system and an automated screening system.

In most virtual screens, long lists sorted by a single score are compiled and submitted for testing. Most of the active hits tend to appear near the top of such lists. By combining the best representatives from three unrelated scoring methods the final hits never stray too far from the initial active probe.

### Broad Scope of the Invention

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values is stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

While the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-transitory, non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

All references, including publications, patent applications, and patents, cited herein are hereby incorporated by reference to the same extent as if each reference were individually and specifically indicated to be incorporated by reference and were set forth in its entirety herein.

1. A computer system for finding in a collection of molecules, molecules that possess a desired biologically activity, said computer system comprising:
means for carrying out a laboratory assay and generating suggested molecules,
means for determining the biological activity of the suggested molecules,
means to aspirate and dispense liquids, and
a reader means for measuring a light-based signal that directly correlates to a sample's biological activity.

2. A non-transitory computer readable medium storing computer readable instructions which when executed by a computer causes the computer to perform the steps of:
using Computational chemistry (CADD) software, converting 2-dimensional molecular structures to 3-dimensions,
computing 3-dimensional molecular similarity between pairs of 3-dimensional molecular structures,
analyzing the results,
based on the results of the analyzing, compiling a list of suggested molecules to test based on a series of algorithms,
testing said suggested molecules in an assay,
retrieving the results of the assay from a reader and
determining which molecules to submit to the next iteration,
said next iteration comprising repeating the process with molecules determined for submission to the next iteration.

3. The non-transitory computer readable medium of claim 2, further comprising said computer readable instructions causing said computer to compare each molecule available for testing with a limited number of probe molecules which are known to possess the desired biological activity and performing the steps of:
a. Creating a plurality of 3-dimensional structures of each probe molecule, said probes representing different shapes accessible due to rotation of flexible atomic bonds,
b. Comparing each 3-dimensional structure to every molecule in the database, and computing scores that quantify the similarity of each pair,
c. Combining, analyzing, and identifying the best candidates for laboratory testing.

4. The non-transitory computer readable medium of claim 3, further comprising, where the identifying of the best candidates for biological testing comprises the steps of:
4a. Sorting results using a predetermined scoring method,
4b. Generating lists of molecules based on the scoring,
4c. Selecting a top number of molecules from each list, wherein the number selected from each list is calculated by dividing the number of requested suggestions by the number of chosen scoring methods,
4d. Systematically evaluating a plurality of combinations of scoring methods and selecting the scoring method that produces the largest number of active molecules, and
1. receiving input from a user accepting the results,
2. receiving input from a user designating alternative scoring methods, or
3. proceeding automatically with no user intervention.

5. The non-transitory computer readable medium of claim 4, further comprising:
subsequent to step (4d3) saving in a computer database, a list of molecules
generated in step (4.d.) and their physical locations,
5a said computer readable instructions causing instrument control software to instruct a robot arm, based on said list of molecules, to retrieve each vessel containing the molecules which are known to possess the desired biological activity,
5b employing a reader device, analyzing the raw results from the reader, carrying out computations to creates a file containing the biological activity of each tested molecule,
5c storing said file,
5d. running another iteration based on the biological activity of tested molecules in said file.

6. The non-transitory computer readable medium of claim 5, wherein said steps further comprise a two-tiered approach to generating suggested compounds for testing, said two-tiered approach comprising:
e. creating a limited number, of 3-dimensional structures of each database molecule, said structures representing different shapes accessible due to rotation of flexible atomic bonds,
f. performing an analysis to obtain a further list of suggestions that accounts for a minority, of molecules in the database,
g. from the further list of suggested molecules, creating a plurality of 3-dimensional structures from each molecule, and performing an analysis based on the further list of suggested molecules, and
h. selecting a number of the top scoring molecules, as suggestions for actual testing in an assay, said number being less than the further list of suggested molecules.

7. The non-transitory computer readable medium of claim 6, wherein said plurality is on the order of magnitude of 1000.

8. The non-transitory computer readable medium of claim 6, wherein said top scoring molecules are on the order of magnitude of 100.

9. The non-transitory computer readable medium of claim 6, wherein said limited number of 3-dimensional structures of each database molecule is in the range from 1 to 10% of the molecules in the database.

10. The non-transitory computer readable medium of claim 6, wherein said limited number of 3-dimensional structures of each database molecule is in the range from 1 to 5% of the molecules in the database.

11. The non-transitory computer readable medium of claim 2, wherein similarity is based upon their similarity in shape, size and/or electrical charge to one or more molecules that are known to be active.

12. A method for finding in a collection of molecules, molecules that possess a desired biologically activity, said method comprising:
using a computer processor,
a—processing computational chemistry (CADD) software and converting 2-dimensional molecular structures to 3-dimensions,
b—computing 3-dimensional molecular similarity between pairs of 3-dimensional molecular structures,
c—analyzing the results,
d—based on the results of the analyzing, compiling in a computer database, a list of suggested molecules to tested,
e—testing the suggested molecules in an assay,
f—retrieving the results from the assay and determining which molecules to submit to the next iteration, said next iteration comprising repeating the process with molecules determined for submission to the next iteration.

13. The method of claim 12, wherein said testing the suggested molecules in an assay comprises determining the biological activity of the suggested molecules, using a reader means for measuring a light-based signal that directly correlates to a sample's biological activity.
